(19) United States
(12) Patent Application Publication
(10) Pub. No.: US 2026/0255438 A1
(43) Pub. Date: Aug. 27, 2026

(54) EXTERNAL PROVISIONING OF EXPECTED INACTIVITY TIME PARAMETER

(71) Applicant: Samsung Electronics Co., Ltd., Gyeonggi-do (KR)

(72) Inventors: David Gutierrez ESTEVEZ, Middlesex (GB); Mahmoud WATFA, Middlesex (GB); Chadi KHIRALLAH, Middlesex (GB)

(21) Appl. No.: 18/993,882

(22) PCT Filed: Aug. 8, 2023
(86) PCT No.: PCT/KR2023/011707

§ 371 Date: Jan. 13, 2025

(30) Foreign Application Priority Data
Aug. 10, 2022 (GB) 2211704.8
Jun. 28, 2023 (GB) 2309781.9

(51) Int. Cl. H04W 76/38; H04W 76/20

(52) U.S. Cl. CPC H04W 76/38; H04W 76/20

(57) ABSTRACT

The disclosure relates to a 5G or 6G communication system for supporting a higher data transmission rate. A method performed by a Unified Data Management (UDM) entity in a mobile communication system, the method comprising: receiving, from a Network Function (NF) entity, a first message for subscribing an expected user equipment (UE) behaviour parameter; receiving, from a Network Exposure Function (NEF) entity, a second message for requesting a management of a provisioned parameter, the second message including the provisioned parameter; and transmitting, to the NF entity, a third message for notifying the expected UE behaviour parameter based on the provisioned parameter, the third message including information on an expected protocol data unit (PDU) session inactivity time during which UE is to be inactive for a traffic of a specific application.

### TECHNICAL FIELD

The present disclosure relates to the external provisioning of an expected inactivity time parameter in 5G NR systems, and in particular methods and apparatus for the external provisioning of an expected inactivity time parameter associated with AI/ML traffic.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Wireless or mobile (cellular) communications networks in which a mobile terminal (UE, such as a mobile handset) communicates via a radio link with a network of base stations, or other wireless access points or nodes, have undergone rapid development through a number of generations. The 3^{rd} Generation Partnership Project (3GPP) design, specify and standardise technologies for mobile wireless communication networks. Fourth Generation (4G) and Fifth Generation (5G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks. One such new framework is the use of Artificial Intelligence/Machine Learning (AI/ML) for the optimisation of the operation of 5G networks.

In 5G systems, training/learning of AI/ML can be performed at the UE and/or at the network. For example, training may be completed or mostly completed at the UE, which is termed as Federated Learning (FL). Alternatively, training may be fully centralized in the network (including the gNBs). Hybrid models of the above two variants also exist.

The training of AI/ML models or the gathering of data necessary to perform AI/ML model training may entail significant network traffic and therefore it would be beneficial if information on expected AI/ML learning traffic is available to the network so that network resources can be effectively managed.

The content of the following documents is referred to below and/or their content provides useful background information that the following disclosure should be considered in the context of:
3GPP TS 22.261 V18.5.0
3GPP TS 23.501 V17.5.0
3GPP TS 23.502 V17.5.0
3GPP TS 24.501 V17.7.1
3GPP TS 23.288 V17.5.0
3GPP TR 23.700-80 V0.3.0

### DISCLOSURE OF INVENTION

### Solution to Problem

A method performed by a Unified Data Management (UDM) entity in a mobile communication system, the method comprising: receiving, from a Network Function (NF) entity, a first message for subscribing an expected user equipment (UE) behaviour parameter; receiving, from a Network Exposure Function (NEF) entity, a second message for requesting a management of a provisioned parameter, the second message including the provisioned parameter; and transmitting, to the NF entity, a third message for notifying the expected UE behaviour parameter based on the provisioned parameter, the third message including information on an expected protocol data unit (PDU) session inactivity time during which UE is to be inactive for a traffic of a specific application.

A Unified Data Management (UDM) entity in a mobile communication system, the UDM entity comprising: a transceiver; and a controller coupled with the transceiver and configured to: receive, from a Network Function (NF) entity, a first message for subscribing an expected user equipment (UE) behaviour parameter, receive, from a Network Exposure Function (NEF) entity, a second message for requesting a management of a provisioned parameter, the second message including the provisioned parameter, and transmit, to the NF entity, a third message for notifying the expected UE behaviour parameter based on the provisioned parameter, the third message including information on an expected protocol data unit (PDU) session inactivity time during which UE is to be inactive for a traffic of a specific application.

A method performed by a Network Function (NF) entity in a mobile communication system, the method comprising: transmitting, to a Unified Data Management (UDM) entity, a first message for subscribing an expected user equipment (UE) behaviour parameter; and receiving, from the UDM entity, a third message for notifying the expected UE behaviour parameter based on a provisioned parameter, the third message including information on an expected protocol data unit (PDU) session inactivity time during which UE is to be inactive for a traffic of a specific application.

A Network Function (NF) entity in a mobile communication system, the NF entity comprising: a transceiver; and a controller coupled with the transceiver and configured to: transmit, to a Unified Data Management (UDM) entity, a first message for subscribing an expected user equipment (UE) behaviour parameter, and receive, from the UDM entity, a third message for notifying the expected UE behaviour parameter based on a provisioned parameter, the third message including information on an expected protocol data unit (PDU) session inactivity time during which UE is to be inactive for a traffic of a specific application.

### BRIEF DESCRIPTION OF DRAWINGS

FIG. 1 provides a message flow diagram of an external parameter provision method in a 3GPP 5G system.

FIG. 2 provides a schematic diagram of a network entity in accordance with an example of the present disclosure.

FIG. 3 illustrates a structure of a UE according to an embodiment of the disclosure.

FIG. 4 illustrates a structure of a base station according to an embodiment of the disclosure.

### MODE FOR THE INVENTION

It is an aim of certain examples of the present disclosure to provide approaches for the external provision of information on the expected UE and or AI/ML application function behaviour with respect to AI/ML-related traffic in a 3GPP 5G communications system.

The present invention is defined in the independent claims. Further features associated with the present invention are defined in the dependent claims.

Examples in accordance with the present disclosure will now be described in the context of a 5G wireless communication network comprising at least one or more mobile terminals (UEs), one or more base stations (gNB) or RAN, and a core network. The 5G system may also be considered to be formed from one or more mobile terminals and the network, where the network may comprise one or more network entities (e.g. gNB, Access and Mobility Management Function (AMF), Session Management Function (SMF), Core Network (CN) etc.). However, it will be understood that the present disclosure is not limited to only 5G systems but may be applied to other wireless communication systems in which satellite communications are available. Consequently, references to particular 3GPP constructs in certain examples should not be understood as limiting the ability of examples of the present disclosure to be applied to other wireless communication networks.

Artificial Intelligence (AI)/Machine Learning (ML) is being used in a range of application domains across industry sectors. In mobile communications systems, mobile devices (e.g. smartphones, automotive, robots) are increasingly replacing conventional algorithms (e.g. speech recognition, image recognition, video processing) with AI/ML models to enable new and improved applications. A 5G system can at least support three types of AI/ML operations, as set out in 3GPP TS 22.261 V18.5.0.
AI/ML operation splitting between AI/ML endpoints
AI/ML model/data distribution and sharing over 5G system
Distributed/Federated Learning over 5G system

As outlined in clause 4.15.6 of 3GPP TS 23.502 V17.5.0, provisioning capability allows an external party to provision the information, such as expected UE behaviour and service specific parameters to 5G network functions (NFs). For example, expected UE behavioural information may include information on expected UE movement and communication characteristics. Provisioned data can also be used by the other NFs. The Expected UE Behaviour parameters characterise the foreseen behaviour of a UE or a group of UEs.

The following is from Table 4.15.6.3-1: Description of Expected UE Behaviour parameters of 3GPP TS 23.502 V17.5.0, and shows the current parameters that are exposed with respect to the Expected UE behaviour parameters, where this is one set of parameters that can be exposed. Other parameters that do not fall under the category of expected UE behaviour parameters may also be exposed but they are not detailed here.

| Expected UE Behaviour parameter | Description |
|---|---|
| Expected UE Moving Trajectory | Identifies the UE's expected geographical movement |
| | Example: A planned path of movement |
| Stationary Indication | Identifies whether the UE is stationary or mobile |
| | [optional] |
| Communication Duration Time | Indicates for how long the UE will |
| | normally stay in CM-Connected for data |
| | transmission. |
| | Example: 5 minutes. |
| | [optional] |
| Periodic Time | Interval Time of periodic communication |
| | Example: every hour. |
| | [optional] |
| Scheduled Communication | Time and day of the week when the UE is available |
| Time | for communication. |
| | Example: Time: 13:00-20:00, Day: Monday. |
| | [optional] |
| Battery Indication | Identifies power consumption criticality for the UE: if |
| | the UE is battery powered with not rechargeable/not |
| | replaceable battery, battery powered with |
| | rechargeable/replaceable battery, or not battery |
| | powered. |
| | [optional] |
| Traffic Profile | Identifies the type of data transmission: single packet |
| | transmission (UL or DL), dual packet transmission |
| | (UL with subsequent DL or DL with subsequent UL), |
| | multiple packets transmission |
| | [optional] |
| Scheduled Communication | Indicates that the Scheduled Communication Type is |
| Type | Downlink only or Uplink only or Bi-directional [To be |
| | used together with Scheduled Communication Time] |
| | Example: <Scheduled Communication Time>, DL |
| | only. |
| | [optional] |
| Expected Time and Day of | Identifies the time and day of week when the UE is |
| Week in Trajectory | expected to be at each location included in the |
| | Expected UE Moving Trajectory. |
| | [optional] |

The Expected UE Moving Trajectory and the Expected Time and Day of Week in Trajectory may be used by the AMF. All other parameters may be used by the AMF and by the SMF.

The Scheduled Communication Type and the Traffic Profile should not be used by the AMF to release the UE when NAS Release Assistance Information from the UE is available.

In the case of NB-IoT UEs, the parameters may be forwarded to the RAN to allow optimisation of Uu resource allocation for NB-IoT UE differentiation.

Although the parameters listed above cover a number of expected UE behaviours they are not sufficient to meet the requirements of some existing use cases as well as new and emerging use cases, such as those related to AI/ML-based applications.

More specifically, as an example, 5G systems (5GS) support the monitoring of the inactivity time of Protocol Data Unit (PDU) sessions associated with a UE, a functionality residing within the control plane of the CN since it enables decisions being made at a fast timescale, typically much faster than what network management and orchestration systems allow. Hence, 5GS already provide support for individual and dynamic activation and deactivation of each PDU session a UE has established. However, different transitions from PDU session deactivation to activation as well as the associated UE state incur significant control signalling overhead in the network. Therefore, such transitions need to be carefully controlled so that the gains of deactivating PDU sessions will not be offset by the signalling overhead caused by the transitions. In addition, minimizing UE battery power consumption and network resource usage are also affected by PDU transitions. Consequently, assigning an appropriate value to an inactivity timer that associated with a PDU session(s) and leveraging its potential are important tasks within a 5GS.

Although there are existing parameters/data analytics related to UE behaviour, these apply in a general manner to PDU sessions, and therefore the current parameters which are exposed by the 5GS are not sufficient to address specific user cases such as AI/ML-based applications. In particular, since existing parameters/data analytics are provisioned by the 5GS as opposed to being externally provisioned by application functions, which may have improved information on certain types of behaviour, the use of existing parameters/data analytics in predicting specific types of traffic or behaviour (e.g. related to AI/ML) are limited. In other words, there is not currently a parameter(s) that provides a direct indication of expected PDU inactivity/activity. Therefore, it is likely to be difficult to effectively set timers etc. related to PDU activity/inactivity and/or subsequently activate/deactivate PDUs.

More specifically, there is no parameter that is currently exposed in order to notify the network about when a UE is expected to be inactive with respect to a PDU session associated with AI/ML traffic in general, and training traffic (e.g. trained models) in particular. This information however may be useful for the network to optimise its configuration to account for the traffic that is expected when a UE shares or receives an AI/ML model to/from the application server provides data (e.g. training data and/or measurement data) related to an AI/ML model.

### AI/ML Expected Inactivity Time Parameter

In view of the discussions above, in accordance with the present disclosure a new set of externally provisioned parameters (provisioned by an AI/ML related application) is proposed, where this new set of parameters is intended to inform the network about the time at which the UE and/or AI/ML related application is expected to not be active, or the time the UE is expected to be inactive, with respect to transmitting or receiving application AI/ML traffic. This new parameter(s) (i.e. parameter set) may be referred to as Expected Inactivity Time but may be referred to using any appropriate title. As is explained in more detail below, AI/ML traffic may relate to different AI/ML operations (e.g. training, inference, inference monitoring/feedback, model splitting, federated learning, model transmission etc.) and the inactivity time information represented by the Expected Inactivity Time can be used by the network in multiple ways to optimize the handling of the related traffic as well as the performance of the application AI/ML operations. For example, the network may activate/deactivate PDU sessions and/or release a User Plane (UP) connection associated with a PDU session based on the inactivity time or set timers that control other aspects of the network based on the expected inactivity time. As also explained below, the Expected Inactivity Time may further contain a subset of parameters indicating parameters such as maximum inactivity time that is to be expected, minimum inactivity time that is to be expected, and/or different values of the inactivity time for different AI/ML operations as indicated above. Although expected inactivity is primarily considered, in some examples it may be expected activity that is considered, using a parameter termed Expected Activity Time for example. A subset of parameters related to the Expected Activity Time may also consider activity as opposed to inactivity.

The envisaged primary use of the Expected Inactivity Time parameter is that it informs or provide an indication to the network about the expected time when a UE is not predicted to be engaged in transmitting or receiving application AI/ML-related traffic. The network or entities thereof may then configure network parameters appropriately based on such an indication. Alternatively stated, it is the time at which the UE is expected to be inactive in terms of transmitting and/or receiving AI/ML application related data. The Expected Inactivity Time parameter may be considered part of the Expected UE behaviour parameter category, or may be standalone or may be part of any other category of parameters that are exposed.

This externally provisioned parameter may be of use in the network handling of different application AI/ML operations, such as in federated learning (FL) but also in individual UE AI/ML operation, as certain UEs of the FL group may not provide trained data in each iteration of the global model update, or an individual UE may not be doing training and/or transmitting/receiving training models for a while. It is therefore useful for the 5G Core (5GC) to receive this information from the AF so that it knows when to activate/deactivate PDU sessions for an AI/ML application without disrupting the learning process.

In addition, the Expected Inactivity Time parameter may implicitly inform the network whether a synchronous or an asynchronous mode of operation for FL is to be expected, since highly heterogeneous values for the inactivity times of different UEs will mean that they are not expected to provide their model updates at the same time (i.e. asynchronous operation) while similar values implicitly enable a synchronous operation of the UEs. More specifically, the Session Management Function (SMF) may pro-actively re-activate or de-activate a PDU Session used for application AI/ML traffic based on the Expected Inactivity Time parameter, and this operation may depend on the type of AI/ML traffic being handled. The AF can provide additional information on the inactivity time (expected inactivity time, maximum inactivity time, minimum inactivity time, etc.) for which application-specific knowledge on the AI/ML operations may be required and hence the 5GC itself could not derive. For example, the information on the inactivity time can be consumed by SMF so that it knows when to expect application AI/ML data to be transferred (or not transferred) over the network.

In some examples, the AF can subscribe to Network Data Analytics Function (NWDAF) analytics and/or Data Collection Application Function (DCAF) to derive more accurate Expected Inactivity Time parameter values. In this instance, UE communications analytics as described in TS 23.288 V17.5.0 may provide information on predicted values of the inactivity timer that SMF configures in User Plane Function (UPF) for generic PDU sessions, and could be leveraged by the AF by using the procedure in clause 4.15.6.2 of TS 23.502 V17.5.0. Although the Expected Inactivity Time parameter is produced by the AI/ML AF, it may be provided to the network function via an external parameter provisioning process (i.e. via an NEF) and therefore the Expected Inactivity Time may be considered to be received from one or more of the AI/ML AF, NEF, UDM, and Unified Data Repository (UDR) for example. As part of the external parameter provisional process, the NF requiring the proposed parameter(s) may provide a subscribe request to the UDM and then subsequently receive or retrieve the proposed parameters that have been provided by the AI/ML AF, via the NEF, UDM and/or UDR for example.

The Expected Inactivity Time parameter may be a simple parameter i.e. not composite, or may be a set of parameters. The Expected Inactivity Time parameter may refer to expected UE behaviour i.e. when the UE is expected to be inactive but may also contain information about when the AF may request such inactive time prediction. As such, although the proposal herein are explained in reference to the UE, these proposals may also apply to the AF as well. In other words, the provision of parameters concerning AI/ML/related activity are not exclusively related to expected UE behaviour but also the behaviour of other network functions that participate in AI/ML-related matters.

Since the Expected Inactivity Time may refer to a set of parameters, the following parameters are proposed to be supported for external provisioning, where each of these parameters may be used as standalone or in relation with the Expected Inactivity Time parameter.

Expected Inactivity Time: this may be considered to be the primary parameter and it can be used to describe the time at which the UE is expected to be inactive for data transmission (or reception) over a specific or multiple PDU session related to AI/ML operations, the transmission (or reception) of AI/ML-related data over a general PDU session, or a mixture of these. Each of the other parameters may also relate to transmissions over such PDU sessions.
The parameter may be a single parameter or may refer to a set of parameters (see additional parameters below), where this set is in addition (and may be optional) to the indication of the time that the UE is expected to be inactive transmitting data over a specific PDU session related to AI/ML operations.
The PDU session may be established specifically for application AI/ML data using a dedicated identifier (e.g. AI/ML Session ID) or it may be a generic PDU session using a generic identified (e.g. PDU Session ID)
A single parameter can be provisioned generically for all application AI/ML operations or multiple parameters can be provisioned specifically for one or a set of specific AI/ML operations (e.g. training, inference, inference feedback, splitting, FL, etc.)
The time may represent a duration, a point or time, a beginning of a time period or an end of a time period.

Maximum Inactivity Time: this parameter may indicate the maximum duration of inactivity that is expected from a UE transmitting data over a specific PDU session (and/or slice, and/or DNN).
A single parameter can be provisioned generically for all application AI/ML operations or multiple parameters can be provisioned specifically for one or a set of specific AI/ML operations (e.g. training, inference, inference feedback, splitting, FL, etc.)

Minimum Inactivity Time: this parameter may indicate the minimum duration of inactivity that is expected from a UE transmitting data over a specific PDU session.
A single parameter can be provisioned generically for all application AI/ML operations or multiple parameters can be provisioned specifically for one or a set of specific AI/ML operations (e.g. training, inference, inference feedback, splitting, FL, etc.)

Request to modify session inactivity timer indicator: this may indicate whether the network should modify the value of the inactivity timer configured by SMF in User Plane Function (UPF) and associated to the session bearing the application AI/ML data.
A single parameter can be provisioned generically for all application AI/ML operations or multiple parameters can be provisioned specifically for one or a set of specific AI/ML operations (e.g. training, inference, inference feedback, splitting, FL, etc.)

The above list is not exhaustive and other related sub-parameters can be provided as part of the Expected Inactivity Time parameter. For example, time of day, frequency of the UP activation/deactivation, period/duration of the UP activation/deactivation, the QoS, delay parameters related to the transferred traffic, etc.

The parameter(s) proposed above may also be associated with a group of UEs where the group may be engaged in federated learning (FL) and as such the inactivity period may be for the entire group and not just one UE. For this case, the proposals above would still apply. However, in addition to the proposals above, the AF may provide a group ID to identify the group of UEs that are associated with this information, or the AF may provide a list of UEs that are part of the group. If a group ID is provided, then the 5GC NF e.g. Network Exposure Function (NEF), Unified Data Management (UDM), or other nodes, may use the group ID to identify the UE which are part of the group.

In another alternative, the group ID and the list of UEs that are part of the group may also be provided by the AF, or may be part of the subscription information e.g. in the UDM.

The inactivity parameter (i.e. Expected Inactivity Time), and other optional parameters as listed above, which is (are) proposed herein are not only meant for the SMF to determine whether or not, and/or when, a PDU session should be released. This information may in fact not lead to the release of a PDU session but may be useful for the SMF to have knowledge of the overall time when a UE, or sets of UEs, will be engaged in AI/ML traffic exchange and when this may not happen. This can help to ensure that enough resources will be available accordingly where for example during an inactive period the network may downscale its resources in a real-time manner if so needed and if possible. The inactivity parameter may also be provided to any other network function of which it may be of use.

In addition to the above, the inactivity time parameter applied to a group of UEs participating in the FL operation may refer to the complete set of UEs belonging to the group or just a subset of UEs within the group. This is because the FL server may only use a subset of the UEs within the group whose trained models are provided on time to update the global model. The number of allowed UEs within such subset may be provided and/or decided by the AF and/or a NF within the 5CG. Hence, the inactivity time may in some examples only refer to such subset.

In another alternative, it is further proposed that another parameter be exposed optionally instead of the inactivity time that has been described above or optionally in addition to it and the other parameters thereof. The proposed new parameter is a set of information which provides the following indications:

Expected time of reduced activity: where this is the time at which the UE is expected to have a reduced activity in terms of AI/ML data exchange. Note that this reduced activity may refer to a reduction of UE activity in reference to a certain level, where the level may be known already, or the reduced activity may also be associated with a certain data rate information or volume or other information that describe what the reduced activity is. For example, the information may include a certain bit rate for a certain time period. In some examples the reduced level of activity may be zero (e.g. zero bit rate). The information may also include a specific QoS level that is associated with the reduced activity.
One or more of the previous parameters that were proposed for the expected inactivity time may also apply here, e.g. the minimum expected duration of this reduced time of activity, and/or the maximum expected duration of this reduced time of activity, etc.

Expected time of increased activity: where this is the time at which the UE is expected to have an increased activity in terms of AI/ML data exchange. Note that this increased activity may refer to an increase of UE activity in reference to a certain level, where the level may be known already, or the increased activity may also be associated with a certain data rate information or volume or other information that describe what the increased activity is. For example, the information may include a certain bit rate for a certain time period. The increase may be relative to zero activity in some examples. The information may also include a specific QoS level that is associated with the increased activity.
One or more of the previous parameters that were proposed for the expected inactivity time may also apply here, e.g. the minimum expected duration of this reduced time of activity, and/or the maximum expected duration of this reduced time of activity, etc.

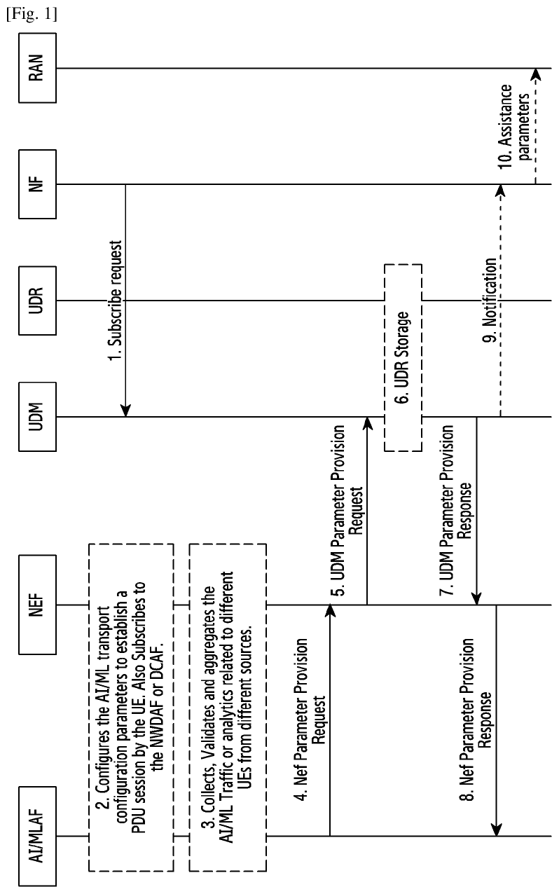

The above parameters may be provisioned to the 5GC by using the external parameter provisioning procedure specified in clause 6.36.2 of TR 23.700-80 V0.3.0, where the new parameters are provisioned in step 4. In addition, in step 10 SMF may take necessary actions to leverage the information received within the Expected Inactive Time parameter (e.g. modification of the inactivity timer in UPF, de-activation of the UP connection associated to a PDU session, re-activation of the UP connection associated to a PDU session, etc.). Furthermore, the SMF may consider other parameters (e.g. QoS, delay, other) in addition to the expected inactivity timer before deciding whether to activate or deactivate a given PDU session. Details of 6.36.2 of TR 23.700-80 V0.3.0 are set out below and in FIG. 1, where the numbering corresponds to that of the messages in FIG. 1. As can be seen from the description below and FIG. 1, the newly proposed parameter(s) will may be provisioned from the AF (e.g. AI/ML related AF) to the NF (e.g. SMF) via the NEF and UDM/UDR.
1. The NF (e.g. AMF, SMF) can subscribe to Group Subscription data from UDM. The NF may request AI/ML assisted parameters as a set of external provisioning parameters.
2. The AI/ML AF may configure the AIML transport configuration information using partly the procedure to influence the traffic routing as defined by clause 4.3.6 of TS 23.502 [4] (see also enhancements in Solution #13). This is to establish User Plane PDU session(s) by UE or by group of UEs to the AI/ML AF. The PDU session can be used by AI/ML AF to collect AI/ML traffic from the UE(s) (e.g. intermediate data, local training data, inference results or model performance). This is in addition to the subscription to the NWDAF for UE mobility and/or UE communication analytics for a UE or group of UEs.

The AI/ML AF may also subscribe to the NWDAF for existing collective behaviour information as part of NF load analytics (e.g. by setting an area of interest for the group of UEs as part of analytics filters).
3. The AI/ML AF collects, validates, aggregates and normalises the collected AI/ML traffic and analytics related to different UEs from multiple sources (e.g. AI/ML application client on the UE, NWDAF or DCAF).
4. The AI/ML AF provides one or more AI/ML assisted parameter(s), to be created, updated or deleted at the UDR using existing NEF services (e.g. in case of untrusted AI/ML AF). Alternatively, a trusted AI/ML AF may directly interact with UDM/UDR without NEF intervention.

(When applicable) NEF checks whether the requestor is allowed to perform the requested service operation by checking requestor's identifier (e.g. the AI/ML AF Identifier). The payload of the request is covered in Table 6.36.1-1 in addition to other existing parameters from clause 4.15.6.3 of TS 23.502 [4].
5. If the AI/ML AF is authorised by the NEF to provision the parameter(s), the NEF requests to create, update and store, or delete the provisioned parameter(s) as part of existing UDM services.

If the AI/ML AF is not authorised to provision the parameter(s), then the NEF continues in step 8 indicating the reason for failure in NEF response message. Steps 9 and 10 can also be skipped.

The NEF can translate the AI/ML AF Identifier to DNN and/or S-NSSAI of the AI/ML AF or any associated AI/ML Application Server(s) when applicable for an untrusted AF.
6. UDM interacts with UDR to create, update, or delete the AI/ML assisted parameters based on the existing services (subject to authorisation). The UDM classifies the received AI/ML assisted parameters into e.g. AMF associated, SMF associated, (including validity time) and then stores them under the corresponding data within the UDR.
7. UDM responds the request with existing UDM services. If the procedure fails, the cause value indicates the reason.
8. NEF responds the request with existing NEF services. If the procedure fails, the cause value indicates the reason.
9. UDM notifies to the subscribed Network Function (e.g. AMF, SMF) of the updated UE and/or Group subscription data via UDM Notify message.
10a. If the NF is AMF, the AMF identifies whether there are overlapping parameter set(s) and merges the parameter set(s), e.g. in the AI/ML assisted Expected UE Behaviour parameters, if necessary. The AMF uses the received AI/ML assisted parameters to derive the appropriate UE configuration of the NAS parameters and to derive Core Network assisted RAN parameters.

In one alternative, if the AMF receives more than one parameter per entry (i.e. a set of parameters), the AMF may choose one of the parameters based on the associated probability assertion (e.g. the one with the highest probability is chosen) or based on the evaluation metrics that are received for each case (e.g. level of accuracy). The AMF may also choose a parameter out of the set based on local policies and/or subscription information. The AMF may then act as described above once a parameter has been selected.

If the NF is SMF, the SMF stores the received AI/ML assisted parameters and associates them with a PDU Session based on the DNN and S-NSSAI included in the message from UDM. The SMF identifies whether there are overlapping parameter set(s), e.g. in the AI/ML assisted Expected UE behaviour parameters and merges the parameter set(s), if necessary. The SMF may use the received AI/ML assisted parameters as follows:
SMF configures the UPF accordingly. The SMF may use the Communication Duration Time or Battery Indication combined with probability assertion per entry to determine a collective pattern of deactivating UP connection for AI/ML traffic (e.g. across a group of UEs for FL operation) and to perform CN-initiated selective deactivation of UP connection of an existing PDU Session.

If the SMF receives more than one parameter per entry (i.e. a set of parameters), the SMF may choose one of the received parameters based on an associated probability assertion (e.g. the one with the highest probability is chosen) or based on the evaluation metrics that are received for each case (e.g. the level of accuracy). The SMF may also choose a parameter out of the set based on local policies and/or subscription information. The SMF may then act as described above once a parameter has been selected.
The SMF may derive SMF derived CN-assisted RAN information for the PDU Session. The SMF provides the SMF derived CN assisted RAN information to the AMF as described in PDU Session establishment procedure or PDU Session modification procedure.

A UE which is arranged to operate in accordance with any of the examples of the present disclosure described above includes a transmitter arranged to transmit signals to one or more RANs, including but not limited to a satellite network and a 3GPP RAN such as 5G NR network; a receiver arranged to receive signals from one or more RANs and other UEs; and a controller arranged to control the transmitter and receiver and to perform processing in accordance with the above described methods. The transmitter, receiver, and controller may be separate elements, but any single element or plurality of elements which provide equivalent functionality may be used to implement the examples of the present disclosure described above.

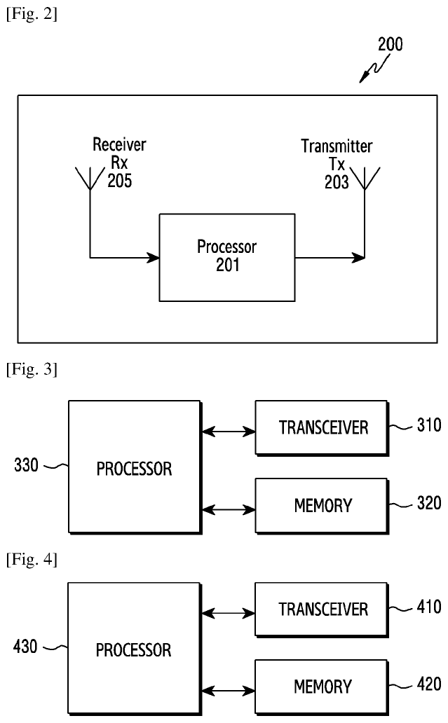

FIG. 2 is a block diagram of an exemplary network entity that may be used in examples of the present disclosure. For example, the UE, entities of the core network or RAN (e.g. eNB, gNB or satellite) may be provided in the form of the network entity illustrated in FIG. 2. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure. Accordingly, FIG. 2 may represent any of the above mentioned network entities, such as SMF, AMF, AI/ML AF, NEF, gNB for example.

The entity 200 comprises a processor (or controller) 201, a transmitter 203 and a receiver 205. The receiver 205 is configured for receiving one or more messages from one or more other network entities, for example as described above. The transmitter 203 is configured for transmitting one or more messages to one or more other network entities, for example as described above. The processor 201 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

A particular network entity may be implemented as a network element on a dedicated hardware, as a software instance running on a dedicated hardware, and/or as a virtualised function instantiated on an appropriate platform, e.g. on a cloud infrastructure.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the present disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. Examples of the present disclosure extend to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be used without departing from the scope of the invention, which is defined in any accompanying claims.

Further examples in accordance with the present disclosure are set out in the following numbered clauses.

According to an embodiment of the present disclosure, a method for a first network entity (e.g. AF) in a 5G mobile communications network comprising one or more user equipment (UE), and a plurality of network entities, wherein the method comprises:
transmitting, from the first network entity to a second network entity (e.g. SMF, AMF), an activity indication (e.g. Expected Inactivity Time) indicating expected Artificial Intelligence/Machine Learning (AI/ML)-related activity associated with a UE and/or the first network entity.

According to an embodiment of the present disclosure, wherein the activity indication indicates expected AI/ML-related traffic associated with the UE and/or the first network entity.

According to an embodiment of the present disclosure, wherein the activity indication indicates expected AI/ML-related activity associated with a specific Protocol Data Unit (PDU) session.

According to an embodiment of the present disclosure, wherein the activity indication indicates a time during which the UE and/or first network entity is expected to be inactive with respect to transmitting and/or receiving AI/ML-related data.

According to an embodiment of the present disclosure, wherein the activity indication includes one or more parameters providing an indication of expected AI/ML-related activity, the one or more parameters indicating one or more of:
a time during which the UE is expected to be inactive with respect to the transmission/reception of data related to AI/ML operations,
a maximum inactivity duration the UE is expected to be inactive with respect to the transmission/reception of data related to AI/ML operations,
a minimum inactivity duration the UE is expected to be inactive with respect to the transmission/reception of data related to AI/ML operations,
a request to modify an expected inactivity, maximum inactivity time, or minimum activity time,
a time of day the UE is expected to be inactive with respect to the transmission/reception of data related to AI/ML operations,
a time or duration during which the UE is expected to reduced transmission/reception of data related to AI/ML operations, and
a time or duration during which the UE is expected to increase transmission/reception of data related to AI/ML operations.

According to an embodiment of the present disclosure, wherein the activity indication is associated with a group of UEs.

According to an embodiment of the present disclosure, wherein the method further comprises deriving by the first network entity the activity indication based on one or more of the following: scheduled or unscheduled AI/ML training, inference, inference monitoring/feedback, model splitting, federated learning, and model transmission, UE communication analytics information received from a data and/or communications analytics function (e.g. Network Data Analytics Function or Data Collection Application Function) and/or the application client at the UE.

According to an embodiment of the present disclosure, wherein the second network entity is a 5G Network Function (NF).

According to an embodiment of the present disclosure, wherein the 5G network function is one of a Session Management Function (SMF) and an Access and Mobility Management Function (AMF).

According to an embodiment of the present disclosure, wherein the first network entity is an AI/ML-related 5G Application Function (AF)

According to an embodiment of the present disclosure, wherein the activity indication is transmitted from the first network entity to the second network entity via a third network entity (e.g. UDM).

According to an embodiment of the present disclosure, wherein the activity indication is transmitted to the second network entity via a Network Exposure Function (NEF).

According to an embodiment of the present disclosure, a network entity for a 5G mobile communications network comprising one or more user equipment (UE), and a plurality of network entities, wherein the network entity is configured to implement the method of any preceding clause.

According to an embodiment of the present disclosure, a method for a 5G mobile communications network comprising one or more user equipment (UE), and a plurality of network entities, wherein the method comprises:
transmitting, from the first network entity to a second network entity (e.g. SMF, AMF), an activity indication indicating expected Artificial Intelligence/Machine Learning (AI/ML)-related activity associated with a UE and/or the first network entity (e.g. AI/ML AF); and
configuring by the second network entity one or more network parameters based on the activity indication.

According to an embodiment of the present disclosure, wherein the configuration of the one or more network parameters based on the activity indication includes one or more of activating and/or deactivating the user plane connection associated to a PDU session over which AI/ML-related traffic associated with the UE or first network entity is communicated, and reducing and/or increasing a resource allocation for the transmission of AI/ML-related traffic associated with the UE or first network entity.

According to an embodiment of the present disclosure, a method for external provision of expected User Equipment (UE) behaviour parameters in a mobile communications network comprising a Unified Data Manager (UDM), a Network Function (NF), an Application Function (AF), a Network Exposure Function (NEF), a Unified Data Repository (UDM), and a UE, the method comprising: receiving, at the UDM from the NF, a subscribe request including a request for one or more expected UE behaviour parameters; receiving, at the NEF from the AF, an NEF parameter provision request including the one or more expected UE behaviour parameters; transmitting, from the NEF to the UDM, a UDM parameter provision request including the one or more expected UE behaviour parameters; updating, by the UDM, the UDR with the one or more expected UE behaviour parameters; and transmitting, by the UDM to the NF, a notification of the updated one or more expected UE behaviour parameters, wherein the one or more expected UE behaviour parameters includes an expected inactivity time identifying an expected time during which the UE will not be transmitting application-specific data over a Protocol Data Unit (PDU) session, and wherein the NF is a Session Management Function (SMF) or an Access and Mobility Management Function (AMF), and the method further comprises the NF configuring one or more network parameters based on the expected inactivity time.

According to an embodiment of the present disclosure, the AF is an Artificial Intelligence/Machine Learning (AI/ML) AF.

According to an embodiment of the present disclosure, the application-specific data is AI/ML-related data.

According to an embodiment of the present disclosure, when the NF is an SMF, the configuring one or more network parameters includes one or more of deactivating and/or activating the PDU session based on the expected inactivity time, and reducing and/or increasing a resource allocation for the transmission of the application-specific data based on the expected inactivity time.

According to an embodiment of the present disclosure, the AF is subscribed to a Network Data Analytics Function (NWDAF) and/or a Data Collection Application Function (DCAF) and derives the expected inactivity time based on information from the NWDAF and/or DCAF.

According to an embodiment of the present disclosure, the method further comprises deriving by the AF the expected inactivity time based on one or more of the following: scheduled or unscheduled AI/ML training, inference, inference monitoring/feedback, model splitting, federated learning, model transmission, and UE communication analytics information received from a Network Data Analytics Function (NWDAF) and/or a Data Collection Application Function (DCAF).

According to an embodiment of the present disclosure, the transmitting, from the NEF to the UDM, a UDM parameter provision request including the one or more expected UE behaviour parameters includes determining by the NEF if the AF is authorised to provision the one or more expected UE behaviour parameters, and transmitting the UDM parameter provision request if the AF is authorised.

According to an embodiment of the present disclosure, the mobile communications network system is a 3GPP 5G mobile communications network.

According to an embodiment of the present disclosure, a mobile communications network comprising a unified data manager (UDM), a network function (NF), an application function (AF), a network exposure function (NEF), a unified data repository (UDR), and one or more user equipment (UE), wherein the mobile communication system is configured to perform the above-described operations.

According to an embodiment of the present disclosure, a method of a Unified Data Manager (UDM) for external provision of expected User Equipment (UE) behaviour parameters in a mobile communications network comprising a UE, a network exposure function (NEF), a network function (NF), a unified data repository (UDR), and the unified data manager (UDM), and the method comprising: receiving, at the UDM from the NF, a subscribe request including a request for one or more expected UE behaviour parameters;
receiving, from the NEF, a UDM parameter provision request including the one or more externally provisioned expected UE behaviour parameters; updating, by the UDM, the UDR with the one or more externally expected UE behaviour parameter, transmitting, by the UDM to the NF, a notification of the updated one or more expected UE behaviour parameters; wherein the one or more externally provisioned expected UE behaviour parameters includes an expected inactivity time indicating an expected time during which the UE will not be transmitting application-specific data over a Protocol Data Unit (PDU) session.

According to an embodiment of the present disclosure, the expected inactivity time is provisioned by an Artificial Intelligence/Machine Learning (AI/ML) Application Function.

According to an embodiment of the present disclosure, the application-specific data is AI/ML-related data.

According to an embodiment of the present disclosure, a network entity of a mobile communications network is configured to perform the above-described operations. According to an embodiment of the present disclosure, a 5G mobile communication network comprising one or more user equipment (UE), and a plurality of network entities, wherein the 5G mobile communication network is configured to implement the method of clauses 14 or 15.

FIG. 3 illustrates a structure of a UE according to an embodiment of the disclosure.

As shown in FIG. 3, the UE according to an embodiment may include a transceiver 310, a memory 320, and a processor 330. The transceiver 310, the memory 320, and the processor 330 of the UE may operate according to a communication method of the UE described above. However, the components of the UE are not limited thereto. For example, the UE may include more or fewer components than those described above. In addition, the processor 330, the transceiver 310, and the memory 320 may be implemented as a single chip. Also, the processor 330 may include at least one processor.

The transceiver 310 collectively refers to a UE receiver and a UE transmitter, and may transmit/receive a signal to/from a base station or a network entity. The signal transmitted or received to or from the base station or a network entity may include control information and data. The transceiver 310 may include a RF transmitter for up-converting and amplifying a frequency of a transmitted signal, and a RF receiver for amplifying low-noise and down-converting a frequency of a received signal. However, this is only an example of the transceiver 310 and components of the transceiver 310 are not limited to the RF transmitter and the RF receiver.

Also, the transceiver 310 may receive and output, to the processor 330, a signal through a wireless channel, and transmit a signal output from the processor 330 through the wireless channel.

The memory 320 may store a program and data required for operations of the UE. Also, the memory 320 may store control information or data included in a signal obtained by the UE. The memory 320 may be a storage medium, such as read-only memory (ROM), random access memory (RAM), a hard disk, a CD-ROM, and a DVD, or a combination of storage media.

The processor 330 may control a series of processes such that the UE operates as described above. For example, the transceiver 310 may receive a data signal including a control signal transmitted by the base station or the network entity, and the processor 330 may determine a result of receiving the control signal and the data signal transmitted by the base station or the network entity.

FIG. 4 illustrates a structure of a base station according to an embodiment of the disclosure.

As shown in FIG. 4, the base station according to an embodiment may include a transceiver 410, a memory 420, and a processor 430. The transceiver 410, the memory 420, and the processor 430 of the base station may operate according to a communication method of the base station described above. However, the components of the base station are not limited thereto. For example, the base station may include more or fewer components than those described above. In addition, the processor 430, the transceiver 410, and the memory 420 may be implemented as a single chip. Also, the processor 430 may include at least one processor.

The transceiver 410 collectively refers to a base station receiver and a base station transmitter, and may transmit/receive a signal to/from a terminal (UE) or a network entity. The signal transmitted or received to or from the terminal or a network entity may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

Also, the transceiver 410 may receive and output, to the processor 430, a signal through a wireless channel, and transmit a signal output from the processor 430 through the wireless channel.

The memory 420 may store a program and data required for operations of the base station. Also, the memory 420 may store control information or data included in a signal obtained by the base station. The memory 420 may be a storage medium, such as read-only memory (ROM), random access memory (RAM), a hard disk, a CD-ROM, and a DVD, or a combination of storage media.

The processor 430 may control a series of processes such that the base station operates as described above. For example, the transceiver 410 may receive a data signal including a control signal transmitted by the terminal, and the processor 430 may determine a result of receiving the control signal and the data signal transmitted by the terminal.

1. A method performed by a Unified Data Management (UDM) entity in a mobile communication system, the method comprising:
receiving, from a Network Function (NF) entity, a first message for subscribing an expected user equipment (UE) behaviour parameter;
receiving, from a Network Exposure Function (NEF) entity, a second message for requesting a management of a provisioned parameter, the second message including the provisioned parameter; and
transmitting, to the NF entity, a third message for notifying the expected UE behaviour parameter based on the provisioned parameter, the third message including information on an expected protocol data unit (PDU) session inactivity time during which UE is to be inactive for a traffic of a specific application.

2. The method of claim 1, wherein a timer for deactivating a PDU session is configured based on the expected PDU session inactivity time.

3. The method of claim 2, wherein the traffic of the specific application is a AI (Artificial Intelligence)/ML (Machine Learning) related data.

4. The method of claim 2, wherein the NF entity includes a session management function (SMF) entity or an access and mobility management function (AMF) entity.

5. A Unified Data Management (UDM) entity in a mobile communication system, the UDM entity comprising:
a transceiver; and
a controller coupled with the transceiver and configured to:
receive, from a Network Function (NF) entity, a first message for subscribing an expected user equipment (UE) behaviour parameter,
receive, from a Network Exposure Function (NEF) entity, a second message for requesting a management of a provisioned parameter, the second message including the provisioned parameter, and
transmit, to the NF entity, a third message for notifying the expected UE behaviour parameter based on the provisioned parameter, the third message including information on an expected protocol data unit (PDU) session inactivity time during which UE is to be inactive for a traffic of a specific application.

6. The UDM entity of claim 5, wherein a timer for deactivating a PDU session is configured based on the expected PDU session inactivity time.

7. The UDM entity of claim 6, wherein the traffic of the specific application is a AI (Artificial Intelligence)/ML (Machine Learning) related data.

8. The UDM entity of claim 6, wherein the NF entity includes a session management function (SMF) entity or an access and mobility management function (AMF) entity.

9. A method performed by a Network Function (NF) entity in a mobile communication system, the method comprising:
transmitting, to a Unified Data Management (UDM) entity, a first message for subscribing an expected user equipment (UE) behaviour parameter; and
receiving, from the UDM entity, a third message for notifying the expected UE behaviour parameter based on a provisioned parameter, the third message including information on an expected protocol data unit (PDU) session inactivity time during which UE is to be inactive for a traffic of a specific application.

10. The method of claim 9, wherein a timer for deactivating a PDU session is configured based on the expected PDU session inactivity time.

11. The method of claim 10, wherein the traffic of the specific application is a AI (Artificial Intelligence)/ML (Machine Learning) related data.

12. The method of claim 10, wherein the NF entity includes a session management function (SMF) entity or an access and mobility management function (AMF) entity.

13. A Network Function (NF) entity in a mobile communication system, the NF entity comprising:
a transceiver; and
a controller coupled with the transceiver and configured to:
transmit, to a Unified Data Management (UDM) entity, a first message for subscribing an expected user equipment (UE) behaviour parameter, and
receive, from the UDM entity, a third message for notifying the expected UE behaviour parameter based on a provisioned parameter, the third message including information on an expected protocol data unit (PDU) session inactivity time during which UE is to be inactive for a traffic of a specific application.

14. The NF entity of claim 13, wherein a timer for deactivating a PDU session is configured based on the expected PDU session inactivity time.

15. The NF entity of claim 14, wherein the traffic of the specific application is a AI (Artificial Intelligence)/ML (Machine Learning) related data.
